(19) United States
(12) Patent Application Publication
(10) Pub. No.: US 2014/0269486 A1
(43) Pub. Date: Sep. 18, 2014

(54) Relay System

(71) Applicant: Nokia Siemens Networks Oy, Espoo (FI)

(72) Inventors: Ting Zhou, Shanghai (JP); Jing Xu, Shanghai (CN); Haifeng Wang, Shanghai (CN); Zhenhong Li, Shanghai (CN)

(21) Appl. No.: 14/117,739

(22) PCT Filed: May 17, 2011
(86) PCT No.: PCT/CN11/00861

§ 371 Date: Nov. 14, 2013

(51) Int. Cl. H04L 1/00; H04B 7/155

(52) U.S. Cl. CPC H04L 1/0011; H04B 7/155
USPC 370/312; 370/315

(57) ABSTRACT

An apparatus including at least one processor and at least one memory including a computer program code is provided, wherein the at least one memory and the computer program code are configured to, with the at least one processor, cause the apparatus at least to: obtain at least one first data packet and at least one second data packet of which data packets the at least one first data packet has double the size of the at least one second data packet; carry out a parallel-to-serial conversion, an exclusive-or operation and a serial-to-parallel conversion to repetition coding to the at least one first data packet; and combine the at least one first data packet and the at least one second data packet for link adaptation purposes for data conveyance

### FIELD

The invention relates to apparatuses, methods, systems, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

One target of the presentation of a relay node concept is to extend coverage, e.g. by improving penetration inside buildings and enhancing coverage on building shadows. Additionally, relay node extension can also be used for improving high-bit-rate coverage, reducing average transmission power at a user device thus increasing battery life, and enhancing cell capacity and effective throughput, e.g., by increasing cell-edge capacity.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: obtain at least one first data packet and at least one second data packet of which data packets the at least one first data packet has double the size of the at least one second data packet; carry out a parallel-to-serial conversion, an exclusive-or operation and a serial-to-parallel conversion to the at least one first data packet, and combine the at least one first data packet and the at least one second data packet for link adaptation purposes for data conveyance.

According to another aspect of the present invention, there is provided a method comprising: obtaining at least one first data packet and at least one second data packet of which data packets the at least one first data packet has double the size of the at least one second data packet; carrying out a parallel-to-serial conversion, an exclusive-or operation and a serial-to-parallel conversion to the at least one first data packet, and combining the at least one first data packet and the at least one second data packet for link adaptation purposes for data conveyance.

According to yet another aspect of the present invention, there is provided an apparatus comprising: means for obtaining at least one first data packet and at least one second data packet of which data packets the at least one first data packet has double the size of the at least one second data packet; means for carrying out a parallel-to-serial conversion, an exclusive-or operation and a serial-to-parallel conversion to the at least one first data packet, and means for combining the at least one first data packet and the at least one second data packet for link adaptation purposes for data conveyance.

According to yet another aspect of the present invention, there is provided a computer program product embodied on a computer readable medium, the computer program being configured to control a processor to perform: obtaining at least one first data packet and at least one second data packet of which data packets the at least one first data packet has double the size of the at least one second data packet; carrying out a parallel-to-serial conversion, an exclusive-or operation and a serial-to-parallel conversion to the at least one first data packet, and combining the at least one first data packet and the at least one second data packet for link adaptation purposes for data conveyance.

### LIST OF DRAWINGS

Some embodiments of the present invention are described below, by way of example only, with reference to the accompanying drawings, in which

FIG. 1A illustrates an example of a system;

FIG. 1B illustrates another example of a system;

FIG. 2 is a flow chart;

FIGS. 3A and 3B show examples of bit mapping and corresponding constellation diagrams.

FIGS. 4A and 4B show clarifying examples of link adaptation, and

FIG. 5 illustrates examples of an apparatus.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. For example, the embodiments are applicable to both frequency division duplex (FDD) and time division duplex (TDD).

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for advanced evolved) needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

FIG. 1A is an example of a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1A.

The embodiments are not, however, restricted to the system given as an example but a person skilled in the art may apply the solution to other communication systems provided with the necessary properties. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS).

FIG. 1A shows a part of a radio access network of E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1A shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB typically includes transceivers, for instance. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, typically radio links, designed for the purpose. These links may be used for signalling purposes.

The communication system is also able to communicate with other networks, such as a public switched telephone network or the Internet 112.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1A, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1A) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1A may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

The network supporting the concept of Home (e)NodeBs, typically includes a home node B gateway, or HNB-GW. A HNB Gateway (HNB-GW), which is typically installed within an operator's network aggregates traffic from a large number of HNBs back to a core network through lu-cs and lu-ps interfaces.

A home (e)NodeB (sometimes being comparable to a femto or pico node) when coupled to broadband services providing an umbrella cell provides radio coverage to user devices. H(e)NBs may provide the capabilities of a standard node B or a base station as well as the radio resource management functions of a standard radio network controller (RNC). It may be a relay node as well.

As already stated above, long term evolution (LTE) is an air interface designed to admit higher peak data rates and more users per cell. However, these enhancements in radio link technology do not provide improved functionality at cell borders: coverage and capacity remain relatively small due to low signal-to-interference-plus-noise ratio (SINR). In traditional cellular networks, user devices near a node B typically are served with better capacity than the user devices near cell edge. Additionally, since future development in international mobile telecommunications (IMT) leads to usage of higher frequency bands, already concerning LTE-A, the coverage of one base station (node) may be further limited due to increased propagation loss and limited bit energy.

Thus, as a part of development of LTE-Advanced, as a solution to this cell-edge problem, one or more relay nodes (RNs) may be deployed at a cell edge area thus assisting in increasing capacity or extending cell coverage area. This is expected to increase the equality of users in the network. Relays are also seen as a cost-effective solution for coverage limited environments. This offers beneficial business perspectives to operators.

FIG. 1B shows an exemplifying system comprising relay node 114. The system is based on the system of FIG. 1A and it is simplified for the sake of clarity. Similar reference numbers in FIGS. 1A and 1B denote similar parts of the system. As shown in FIG. 1B, user devices may have a radio connection to a (e)NodeB via a relay node instead a direct connection. This is shown by arrows 116 and 118.

Two main types of relay nodes exist: a conventional amplify and forward (AF) relays and decode and forward (DF) relays. Since AF relays do not only amplify a desired signal, but also interference and noise, they are best suited to noise limited systems, whereas DF relays, which detect a desired signal and encode and forward it, are well-suited to interference limited and noisy environments, too. DF relays may operate as repeaters, bridges and/or routers. Received data may be error-corrected, automatically repeated (ARQ) stored and scheduled for retransmission, etc.

Relay node systems typically comprise more than one relay nodes. The relay node systems may be divided into single-hop and multi-hop systems. System complexity is related to the number of hops, therefore in practice, most systems are build to use not more than two hops.

A backhaul typically comprises a transport network between cell sites (base stations) and associated controller, gateway sites or base stations. A backhaul connection in turn provides a user with a communication option inside the network, the usage of other networks, such as the Internet, and cloud services as well, etc. Typically, a relay node does not have a wired, but a wireless backhaul connection. Nevertheless, a wired backhaul connection is possible. A wireless backhaul connection is depicted in FIG. 1B by arrow 120. The relay node itself may be fixed or mobile, for example high-speed trains may be equipped with one or more relay nodes.

Relay nodes may form a group or cluster, one example of such a group is a cooperative cell group (CCG). A user device may be transferred from one relay node to another within the radio coverage area of the group. This may be carried out by means of a handover procedure. In the group, all the relay nodes may be directly coupled to a base station (node), which differs from the multi-hop case.

Further, although the apparatuses have been depicted as single entities, different units, processors and/or memory units (not all shown in FIG. 1B) may be implemented.

Embodiments may also be related to a smart coordinated and cooperative relay system with one or more multiple simultaneous donor systems of multiple operators especially suitable for LTE-Advanced (LTE-A) and international telecommunication union (ITU) international mobile telecommunications advanced (IMT-A) standards, wherein flexible deployment of a number of relay nodes is utilized to provide enhanced cellular coverage in large indoor buildings, hot spots at cell edges, passenger trains or cruise ships, for instance. The cooperative relay system may be based on the CCG concept.

Embodiments are designed for link adaptation. One target is to provide link adaptation for network coding multicast/broadcast. Embodiments are especially suitable for multicasting/broadcasting via channels with different channel quality indicators (CQIs). In the conventional multicast/broadcast, a modulation coding scheme (MCS) for transmission a network coded data packet is selected according to the worst channel quality, which diminishes spectrum efficiency. Embodiments may thus provide improved spectrum efficiency.

In the following, some of the embodiments are disclosed in further details in relation to FIG. 2.

The embodiment of FIG. 2 is usually related to a relay node.

The embodiment starts in block 200.

In block 202, at least one first data packet and at least one second data packet are obtained of which data packets the at least one first data packet has double the size of the at least one first data packet.

Typically, a Node B transmits a data packet of N bits (a second data packet) and a user device transmits another data packet of 2N bits (a first data packet) to a relay node (N is a positive integer number). Both packets have a modulation coding scheme (MCS) of their own, which MCSs do not depend on each other. Used modulation coding schemes or algorithms may be ½ quadrature phase shift keying (QPSK) and ½ binary phase shift keying (BPSK), respectively. Both QPSK and BPSK are phase modulation algorithms. QPSK is sometimes also known as quaternary PSK (phase shift keying), quadriphase PSK, 4-PSK, or even 4-QAM (quadrature amplitude modulation). In the QPSK, four constellation points equispaced on a unit circle each representing a different phase are used for modulating a symbol. Thus, by using the QPSK, two bits per symbol may be encoded. BPSK is sometimes also called phase reversal keying (PRK) or 2PSK. The BPSK is the simplest form of phase shift keying. It uses only two constellation points representing different phases separated by 180°. A constellation diagram depicts a signal as a two-dimensional scatter diagram in the complex plane at symbol sampling instants. More generally, it represents possible symbols that may be selected by a given modulation scheme as points in the complex plane. These modulation coding schemes or algorithms are only examples and do not limit the implementation of embodiments.

In block 204, a parallel-to-serial conversion, an exclusive-or operation and a serial-to-parallel conversion to the at least one first data packet are carried out.

The parallel-to-serial conversion, exclusive-or operation and serial-to-parallel conversion may be thought to form an operation called “bit mapping”. One purpose of this “bit mapping” may be making every two bits to modulate mapping to two constellation points in pairs respectively, in order to maximize (at least to the best possible extent) the Euclidean distance of the constellation points. Typically, in modulating, the best possible maximizing of the Euclidean distance of constellation points is sought for to improve noise resistance, for example.

After receiving data packets from the Node B and the user device successfully, the relay node may carry out repetition coding. In principle, repetition coding is a coding scheme that repeats bits or symbols a desired number of times depending on the data rate. Preferably, the values are repeated in the frequency domain, but they may also be repeated in the time domain. The repetition coding is usually carried out for rate matching before “bit mapping”. Additionally, the relay node may also carry out channel coding before the “bit mapping”.

In the following, the “bit mapping” is further explained by means of some examples.

In a first example (FIG. 3A), wherein the modulation method used for the first data packet is ½ BPSK and the modulation method used for the second data packet is ½ QPSK, the data packet transmitted by the user device is first put through a serial-to-parallel converter to obtain two strings of bits. Every two bits from the parallel strings are XORed (carrying out an exclusive-or, or exclusive disjunction operation) with ‘1 0’ bit-by-bit. The resulted bit strings are put through a parallel-to-serial converter. A serial-to-parallel conversion, carrying out an XOR-operation and a parallel-to-serial conversion may be called “bit mapping”. The original packet transmitted by a node B and the bit-mapped packet are concatenated together for QPSK modulation. The concatenation may be carried out by using a bit-by-bit XOR-operation. The concatenation will be explained in further detail later in context with block 206. The “bit-mapping” aims to make every two bits modulate mapping to two constellation points in pairs respectively, in order to maximize (at least to the best possible extent) the Euclidean distance of the constellation points. This bit mapping and modulation may achieve equivalent capacity with the ½ BPSK. Thus, a modulation coding scheme for data conveyance from a relay node may be ½ QPSK. An example of “bit mapping” and the corresponding constellation diagram is shown in FIG. 3A (mapping from BPSK to QPSK). In the FIG. 3A, a vertical axis (in-phase) 300 and horizontal axis (quadrature) 302 comprise phase values. Point 304 is an original constellation point and it is bit mapped to points 306 and 308. Correspondingly, point 310 is another original constellation point which is bit mapped to points 312 and 314.

In a second example (FIG. 3B), the modulation method used for the first data packet is ½ QPSK and the modulation method used for the second data packet is ½ 16QAM. In the 16 QAM, 4 different phases and 4 different amplitudes are used to create 16 different constellation points.

In this example, the data packet transmitted by a user device is first put through a serial-to-parallel converter to obtain four strings of bits. Every four bits from the parallel strings are XORed with ‘1 1 0 0’ bit-by-bit. The resulted bit strings are put through a parallel-to-serial converter. A serial-to-parallel conversion, carrying out an XOR-operation and a parallel-to-serial conversion may be called “bit mapping”. The original packet transmitted by the Node B and the bit-mapped packet are concatenated together for 16QAM. The concatenation may be carried out by using a bit-by-bit XOR-operation. The concatenation will be explained in further detail later in context with block 206. The “bit-mapping” aims to make every two bits modulate mapping to two constellation points in pairs respectively, in order to maximize (at least to the best possible extent) the Euclidean distance of the constellation points. This “bit mapping” and modulation may achieve equivalent capacity with the ½ 16QAM. Thus, a modulation coding scheme for data conveyance from a relay node may be ½ 16QAM. An example of bit mapping and the corresponding constellation diagram is shown in FIG. 3B (bit mapping from QPSK to 16QAM). In the FIG. 3B, a vertical axis (in-phase) 318 and horizontal axis (quadrature) 316 comprise phase values. Point 320 is an original constellation point and it is bit mapped to points 322 and 324. In this case, point 320 also represents another original constellation point which is bit mapped to points 326 and 328.

It should be appreciated that FIGS. 3A and 3B are only clarifying approximate examples and do not limit the implementation of embodiments.

Further examples of combinations of modulation coding schemes, bit mapping and modulation coding scheme for data conveyance compared to the conventional method is shown in Table 1 below. In the Table 1, “MCS1” is a modulation coding scheme used for a first data packet (from a user device), “MCS2” is a coding scheme used for a second data packet (from a node B or base station), “MCS used conventionally” is a modulation coding scheme used in conventional arrangements, “MCS obtained by embodiment” shows a modulation coding scheme used for data conveyance from a relay node according to an embodiment, and “Bit mapping” shows a used bit mapping.

TABLE 1

| | | | | MCS | |
|---|---|---|---|---|---|
| | | | MCS used | obtained by | Bit |
| Example | MCS1 | MCS2 | conventionally | embodiment | mapping |
| 1 | ⅓ | ⅓ | ⅓ BPSK | ⅓ BPSK | None |
| | BPSK | BPSK | | | |
| 2 | ⅓ | ⅓ | ⅓ BPSK | ⅓ QPSK | As in 1. |
| | BPSK | QPSK | | | example |
| 3 | ½ | ½ | ½ BPSK | ½ QPSK | As in 1. |
| | BPSK | QPSK | | | example |
| 4 | ⅓ | ⅓ | ⅓ QPSK | ⅓ 16QAM | As in 2. |
| | QPSK | 16QAM | | | Example |
| 5 | ½ | ½ | ½ QPSK | ½ 16QAM | As in 2. |
| | QPSK | 16QAM | | | Example |
| 6 | ½ | ⅓ | ½ QPSK | ⅓ 16QAM | As in 2. |
| | QPSK | 16QAM | | | Example |
| 7 | ⅔ | ½ | ⅔ QPSK | ½ 16QAM | As in 2. |
| | QPSK | 16QAM | | | Example |
| 8 | ¾ | ⅔ | ¾ QPSK | ⅔ 16QAM | As in 2. |
| | QPSK | 16QAM | | | Example |

It should be appreciated that it is also possible to use higher level MSCs, such as 64QAM by following the principles shown above, such as using bit mapping according to the second example.

In block 206, the at least one first data packet and the at least one second data packet are combined for link adaptation purposes for data conveyance.

The combining of the at least one second and the processed (see block 204 above) the at least one first data packet may include carrying out concatenating the at least one first data packet after a parallel-to-serial conversion, exclusive-or operation and serial-to-parallel conversion with an original (i.e. unprocessed) at least one first data packet to form a sequence having double the length of the at least one first data packet as originally received. After this “data packet length adaptation” the combining itself is typically carried out by performing an exclusive-or operation bit-by-bit with the concatenated at least one first data packet and the at least one second data packet.

Usually, the data packets are channel coded and rate matched before they are combined.

In the following, conventional link adaptation and link adaptation according to an embodiment are compared to in the case of bi-directional relaying in a general level by means of FIGS. 4A and 4B. Used modulation methods are only exemplifying and the FIGS. 4A and 4B are depicted only for clarification purposes.

In the exemplifying FIG. 4A, a node B (or a base station) 110 transmits a data packet of N bits using ½ QPSK modulation to a relay node 114 400, and a user device 100 transmits another data packet of N bits using ½ BPSK modulation 402. After receiving the data packets the relay node carries out network coding for the data packets and multicasts them as data packets of N bits with ½ BPSK modulation 404. MCS for the multicast/broadcast is chosen according to the worst channel quality.

In the exemplifying FIG. 4B, the node B 110 transmits a second data packet of N bits using ½ QPSK modulation to the relay node 114 406, and the user device 100 transmits a first data packet of 2N bits to the relay node using % BPSK 408. After receiving the data packets, the relay node carries out a parallel-to-serial conversion, an exclusive-or operation and a serial-to-parallel conversion to the at least one first data packet, and carries out a XOR-operation to the data packets bit-by-bit and multicasts them with QPSK modulation 410. MCS for the multicast/broadcast may be chosen according to the Table 1 (from BPSK to QPSK).

One implementation example of embodiments may be Node B multicast and a batch-based packet repairing intra device-to-device cluster. A user device which is acting as a relay node, may carry out network coding to a combination of selected data packets and retransmit the combination packet with BPSK modulation as in the conventional link adaptation or with QPSK modulation as in an embodiment.

The embodiment ends in block 208. The embodiment is repeatable. Arrow 210 shows one possible option for repetition.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

It should be understood that transmitting and/or receiving may herein mean preparing a transmission and/or reception, preparing a message to be transmitted and/or received, or physical transmission and/or reception itself, etc. on a case by case basis. Conveying may mean transmitting and/or receiving, preparing a transmission and/or reception, preparing a message to be transmitted and/or received, or physical transmission and/or reception itself, etc. on a case by case basis as well.

Embodiment provide apparatuses which may be any node, host, user device, network stick or any other suitable apparatus able to carry out processes described above in relation to FIG. 2.

FIG. 5 illustrates a simplified block diagram of an apparatus according to an embodiment especially suitable for operating as a relay node. An embodiment of a method which may be carried out in a relay node is described above in relation to FIG. 2.

As an example of an apparatus according to an embodiment, it is shown an apparatus (500), such as a node device, including facilities in a control unit (504) (including one or more processors, for example) to carry out functions of embodiments, such as combining at least one second data packet and at least one first data packet for link adaptation purposes for data conveyance. Additionally, the control unit or a processor may carry out the “bit mapping” described above. It should be appreciated that, naturally, different phases of embodiments may be carried out in one or a plurality of processors or modules etc. and the division of tasks to different processors or modules etc. may differ from one case to another.

Another example of an apparatus (500) may include at least one processor (504) and at least one memory (502) including a computer program code, the at least one memory and the computer program code configured to, with the at least one processor, cause the apparatus at least to: obtain at least one first data packet and at least one second data packet of which data packets the at least one first data packet has double the size of the at least one second data packet, carry out a parallel-to-serial conversion, an exclusive-or operation and a serial-to-parallel conversion to repetition coding to the at least one first data packet, and combine the repetition coded at least one first data packet and the at least one second data packet for link adaptation purposes for data conveyance.

Yet another example of an apparatus comprises means (504, 506) for obtaining at least one first data packet and at least one second data packet of which data packets the at least one first data packet has double the size of the at least one second data packet, means (502, 504) for carrying out a parallel-to-serial conversion, an exclusive-or operation and a serial-to-parallel conversion to repetition coding to the at least one first data packet, and means (502, 504) for combining the at least one first data packet and the at least one second data packet for link adaptation purposes for data conveyance.

Yet another example of an apparatus comprises an obtainer configured to obtain at least one first data packet and at least one second data packet of which data packets the at least one first data packet has double the size of the at least one second data packet, a processing unit configured to carry out a parallel-to-serial conversion, an exclusive-or operation and a serial-to-parallel conversion to repetition coding to the at least one first data packet, and a combiner configured to combine the at least one first data packet and the at least one second data packet for link adaptation purposes for data conveyance.

It should be appreciated that different units may be implemented as one module, unit, processor, etc, or as a combination of several modules, units, processor, etc.

It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control, etc. depending on the implementation. Receiving may herein mean receiving via antennas from a radio path, carrying out preparations for physical receptions or reception control depending on the implementation, etc. The apparatus may utilize a transmitter and/or receiver which are not included in the apparatus itself, such as a processor, but are available to it, being operably coupled to the apparatus. This is depicted in FIG. 5 as a transceiver 506.

It should be appreciated that the apparatuses may also include other units or parts than those depicted in FIG. 5. Although the apparatus has been depicted as one entity, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above.

Other embodiments provide computer programs embodied on a computer readable medium, configured to control a processor to perform embodiments of the methods described above. The computer readable medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example.

Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
obtain at least one first data packet and at least one second data packet of which data packets the at least one first data packet has double the size of the at least one second data packet;
carry out a parallel-to-serial conversion, an exclusive-or operation and a serial-to-parallel conversion to the at least one first data packet, and
combine the at least one first data packet and the at least one second data packet for link adaptation purposes for data conveyance.

2. The apparatus of claim 1, wherein the at least one second data packet is obtained from a node device and the at least one first data packet is obtained from a user device.

3. The apparatus of claim 1, wherein the data conveyance is multicasting and/or broadcasting.

4. The apparatus of claim 1, wherein the combining further comprises carrying out concatenating the at least one first data packet after the parallel-to-serial conversion, the exclusive-or operation and the serial-to-parallel conversion with an original at least one first data packet to form a sequence having double a length of the at least one first data packet.

5. The apparatus of claim 4, wherein the combining further comprises carrying out an exclusive-or operation bit-by-bit with the concatenated at least one first data packet and the at least one second data packet.

6. The apparatus of claim 1, wherein a modulation coding scheme of the first data packet is ½ binary phase shift keying (BPSK) and a modulation coding scheme of the second data packet is ½ quadrature phase shift keying (QPSK).

7. The apparatus of claim 1, wherein the apparatus comprises a relay node.

8. A computer program comprising program instructions which, when loaded into the apparatus, constitute the modules of claim 1.

9. A method comprising:
obtaining at least one first data packet and at least one second data packet of which data packets the at least one first data packet has double the size of the at least one second data packet;
carrying out a parallel-to-serial conversion, an exclusive-or operation and a serial-to-parallel conversion to the at least one first data packet, and
combining the at least one first data packet and the at least one second data packet for link adaptation purposes for data conveyance.

10. The method of claim 9, wherein the at least one second data packet is obtained from a node device and the at least one first data packet is obtained from a user device.

11. The method of claim 9, wherein the data conveyance is multicasting and/or broadcasting.

12. The method of claim 9, the combining further comprising:
carrying out concatenating the at least one first data packet after the parallel-to-serial conversion, the exclusive-or operation and the serial-to-parallel conversion with an original at least one first data packet to form a sequence having double a length of the at least one first data packet.

13. The method of claim 12, the combining further comprising:
carrying out an exclusive-or operation bit-by-bit with the concatenated at least one first data packet and the at least one second data packet.

14. The method of claim 9, wherein a modulation coding scheme of the first data packet is ½ binary phase shift keying (BPSK) and a modulation coding scheme of the second data packet is ½ quadrature phase shift keying (QPSK).

15. An apparatus comprising means for carrying out the method according to claim 9.

16. A computer program product embodied on a computer readable medium, the computer program being configured to control a processor to perform:
obtaining at least one first data packet and at least one second data packet of which data packets the at least one first data packet has double the size of the at least one second data packet;
carrying out a parallel-to-serial conversion, an exclusive-or operation and a serial-to-parallel conversion to the at least one first data packet, and
combining the at least one first data packet and the at least one second data packet for link adaptation purposes for data conveyance.

17. The computer program product of claim 16, wherein the at least one second data packet is obtained from a node device and the at least one first data packet is obtained from a user device.

18. The computer program product of claim 16, wherein the data conveyance is multicasting and/or broadcasting.

19. The computer program product of claim 18, the combining further comprising:
carrying out concatenating the at least one first data packet after the parallel-to-serial conversion, the exclusive-or operation and the serial-to-parallel conversion with an original at least one first data packet to form a sequence having double a length of the at least one first data packet.

20. The computer program of claim 19, the combining further comprising:
carrying out an exclusive-or operation bit-by-bit with the concatenated at least one first data packet and the at least one second data packet.

21. The computer program of claim 16, wherein a modulation coding scheme of the first data packet is ½ binary phase shift keying (BPSK) and a modulation coding scheme of the second data packet is ½ quadrature phase shift keying (QPSK).
